(19) United States
(12) Patent Application Publication
(10) Pub. No.: US 2024/0324573 A1
(43) Pub. Date: Oct. 3, 2024

(54) EQUINE SHOE

(71) Applicant: EasyCare, Inc., Durango, CO (US)

(72) Inventor: Garrett Ford, Durango, CO (US)

(73) Assignee: EasyCare, Inc., Durango, CO (US)

(21) Appl. No.: 18/623,838

(22) Filed: Apr. 1, 2024

Related U.S. Application Data
(60) Provisional application No. 63/456,189, filed on Mar. 31, 2023.

(51) Int. Cl. A01L 5/00; A01L 3/02

(52) U.S. Cl. CPC A01L 5/00; A01L 3/02

(57) ABSTRACT

An equine shoe including a platform and lateral walls. The lateral wall of the platform having proximal and distal cut outs. The proximal and distal cutouts of the lateral wall allows for free expansion and contraction of a horse hoof through all phases a horses gait. The shoe allows for variable customization to cater to all types of horse hoof width and sizes. The lateral walls can either be a uniform material with the shoe platform or the lateral walls can be separate parts of the shoe to allow custom fixture to the horse hoof. The separate lateral walls can then be heat welded to the platform to create a uniform shoe. Alternatively a cuff can be glue to the horse hoof and be received by a corresponding shoe.

### CROSS-REFERENCE TO RELATED APPLICATIONS

The present disclosure claims the benefit of and priority to U.S. Provisional Patent Application No. 63/456,189, which was filed on Mar. 31, 2023, and which is incorporated herein by reference in its entirety.

### FIELD OF THE INVENTION

This patent application relates to equine shoes with improved fitment and durability.

### BACKGROUND

Modern equine shoes are used to protect the hooves of horses and are often used in lieu of traditional steel or aluminum shoes. Such modern shoes typically includes a sole with a flat top surface that meets the underside of the hoof and an upper that projects upward from the sole and forms a peripheral enclosure for at least part of the hoof of the horse. This enclosure is fixed in size, and different-size hooves require different-size shoes. These shoes are fastened to the wall of the horse's hoof either mechanically, via a variety of fasteners (e.g., hook and loop style fasteners) attached to the upper that strap around the pastern or the wall portion of the hoof. In use, such shoes are installed by spreading open the sides of the upper, slipping the shoe onto the hoof from the front, and securing the shell on the hoof with the intended fastening means.

While each of the many prior-art horseshoes defined by this general description provides advantages over traditional shoe designs, they all suffer from a number of persistent and performance-limiting drawbacks. One significant drawback involves adjustability and fit of the shoe. That is, hooves vary considerably in size thus requiring a variety of shoe sizes and shapes that properly fit each hoof of a horse. Further, for shoes glued to the horse, imprecise fit or rigidity of the shoe can lead to poor adherence and premature detachment/wear. Further still, with regard to shoes that are fastened by mechanical means, the fasteners tend to extend enough outwardly to interfere with the normal movement of the horse's hooves during movement, which often causes a shoe to fall off or catch when the fastener is hit by another shoe.

Another significant drawback involves the amount of effort required to change from one shoe to another depending on the anticipated ground conditions where such shoes will be used. That is, many shoes are semi-permanent or difficult to remove and replace. As a result, horses fitted with a shoe for arena riding are not properly shoed for a rough or rocky trail ride, or wet conditions. Riding in improper shoes for the conditions, in turn, can lead to serious performance degradation or even injury.

What is needed, therefore, is an equine shoe that improves upon or resolves one or more of these drawbacks.

### SUMMARY

This application discloses a customizable shoe that, relative to prior-art shoes, more precisely fits different-sized hooves, allows for variable expansion and contraction of a horse hoof, and provides prolonged adherence and wear. This application further discloses a customizable shoe with a cuff and wall interlockable with a pin system.

In one embodiment, the shoe includes a platform with lateral walls. The lateral walls have proximal and distal cutouts or recesses, which improve adherence and fit. Additionally, the platform has a proximal end, a distal end and a skirt therebetween. The skirt forms a segmented arch and void shaped to receive the frog of the horse hoof. The proximal end of the platform is sized to receive the heel of the horse hoof. Moreover, during the sizing process, the proximal portion of the shoe can be shaved to correspond with the precise shape of the horse hoof heel. The lateral walls can be provided integrally to the shoe platform, or as a separate lateral walls that can be heat-welded or otherwise adhered to the platform.

In another embodiment, the shoe is made of a flexible plastic.

In another embodiment, the platform and the lateral wall is a uniform structure.

In another embodiment, the lateral walls include several holes to facilitate/accommodate attachment by nails.

In another embodiment, a glue such as is used to secure the platform to the sole and heel of the horse.

In another embodiment, at least the proximal end of the shoe being a shaveable material.

In still another embodiment, the shoe provides for a passageway that permits use of a pin to removably interlock the shoe to a cuff that can be adhered to a horse hoof.

### BRIEF DESCRIPTION OF THE DRAWINGS

Embodiments of the application will be described in detail in conjunction with the following Figures.

FIG. 1 is a perspective view of the shoe according to the disclosure.

FIG. 2 is a side view of the shoe of FIG. 1.

FIG. 3 is a front view of the shoe of FIG. 1.

FIG. 4 is a perspective view of the shoe according to the disclosure.

FIG. 5 is a perspective view of the disassembled shoe according to the disclosure.

FIG. 6 is a front view of the disassembled shoe of FIG. 5.

FIG. 7 is a perspective view of the cuff according to the disclosure.

FIG. 8 is a perspective view of the assembled shoe of FIG. 5 according to the disclosure.

FIG. 9 is a top view of the shoe of FIG. 1.

FIG. 10 is a perspective view of a wall and cuff shoe interlocked to a horse hoof with a pin according to this disclosure.

FIG. 11 is a perspective view of a cuff adhered to a horse hoof according to the disclosure.

FIG. 12 is a side view of a shoe according to the disclosure.

FIG. 13 is a front view of a shoe according to the disclosure.

FIG. 14 is a top view of a shoe according to the disclosure.

FIG. 15 is a perspective rear view of a shoe according to the disclosure.

FIG. 16 is a perspective rear view of a shoe and cuff according to the disclosure.

FIG. 17 is a perspective side view of a shoe and cuff according to the disclosure.

FIG. 18 is a top view of a shoe, cuff and pin according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

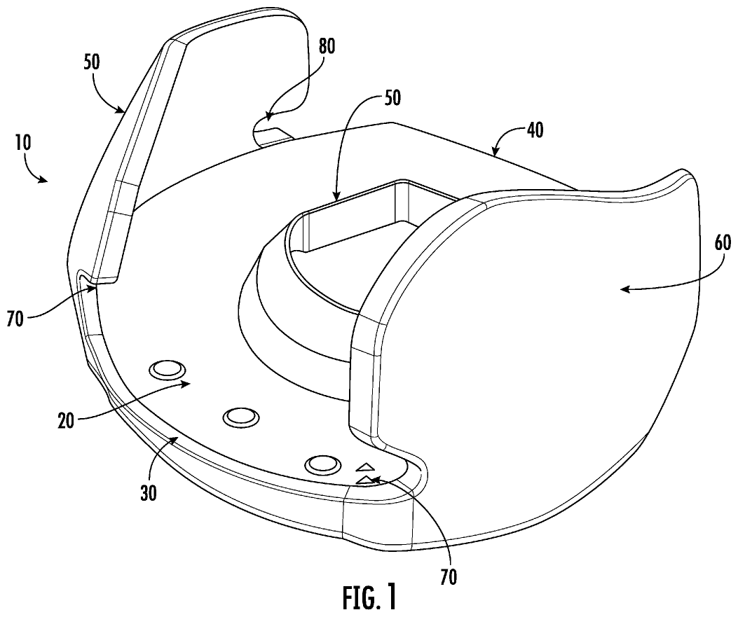

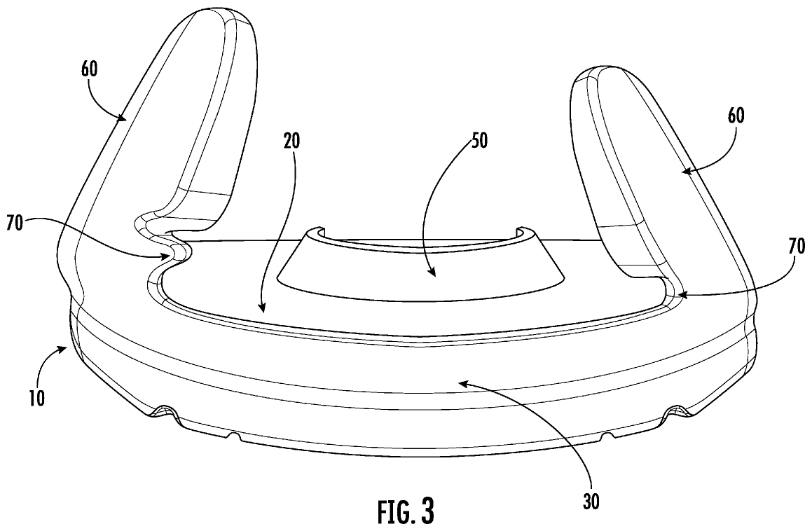

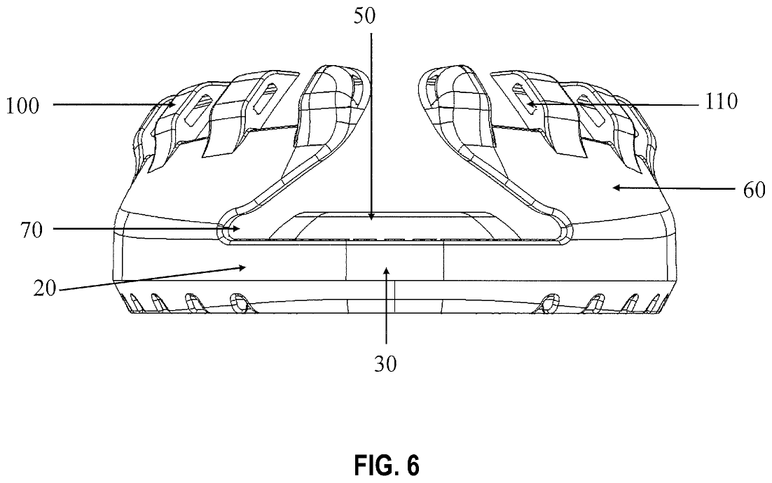

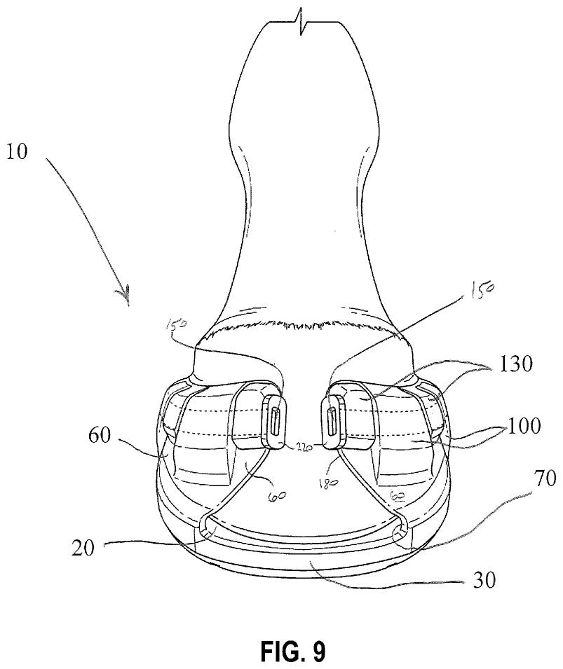

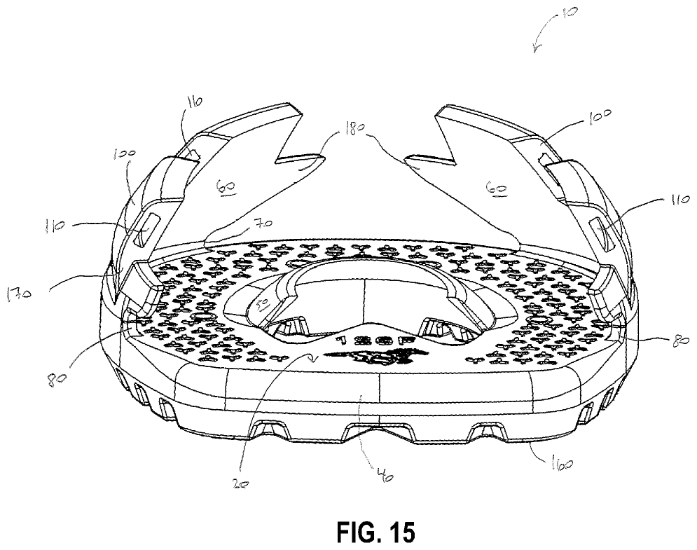

Embodiments of the present disclosure are best understood by referring to FIGS. 1-18 of the drawings, like numerals being used for like and corresponding parts of the various drawings.

### LIST OF REFERENCES

10 Shoe
20 Platform
30 Distal end
40 Proximal end
50 Raised interior skirt
60 Lateral wall
70 Distal cutout
80 Proximal cutout
90 Lateral wall holes
100 Projections
110 Projection passageway
120 Cuff
130 Cuff projection
140 Cuff passageway
150 Pin
160 Tread
170 Slope
180 Wing
190 Central void
200 Superior end
210 Inferior end
220 Pin stop

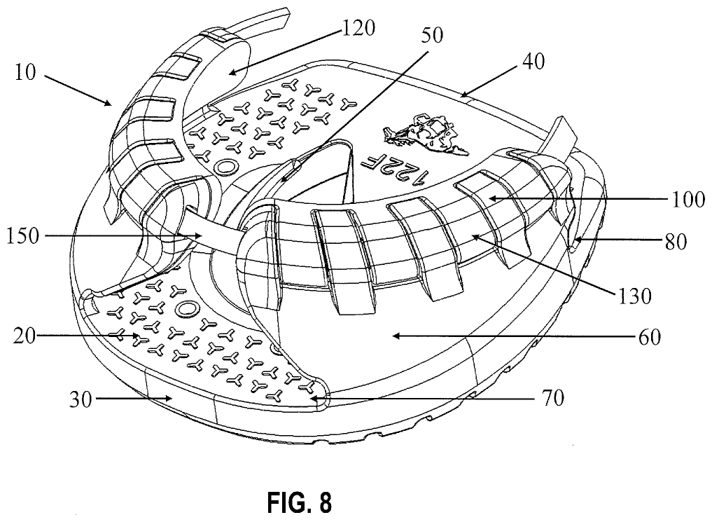

In general, shoe 10 has a platform 20 with a proximal end 40, a distal end 30, and lateral walls 60 that extend from the platform. In the embodiments of FIGS. 1-4, lateral walls 60 form an outer shell of the shoe 10, and are configured to be glued directly to the horse hoof. Alternatively, in the embodiments of FIGS. 8-18, lateral walls 60 can be removably interlocked with pins to cuffs that are glued directly to the horse hoof. The interlocking embodiments permit quick interchangeability of different shoes.

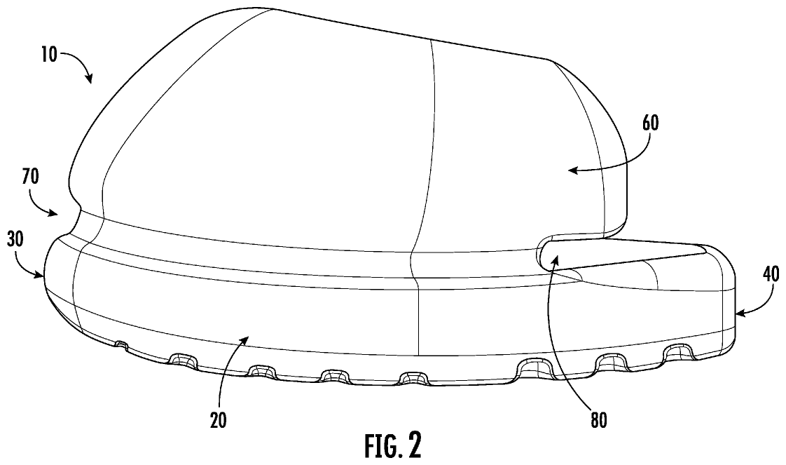

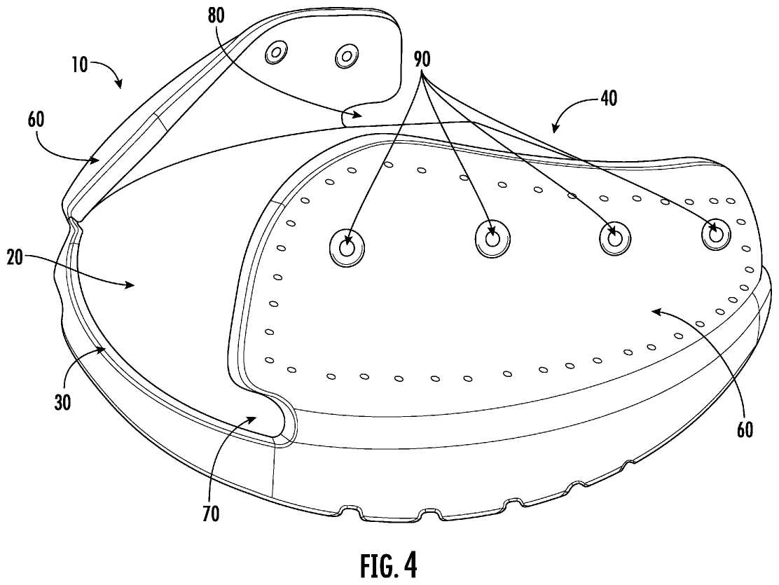

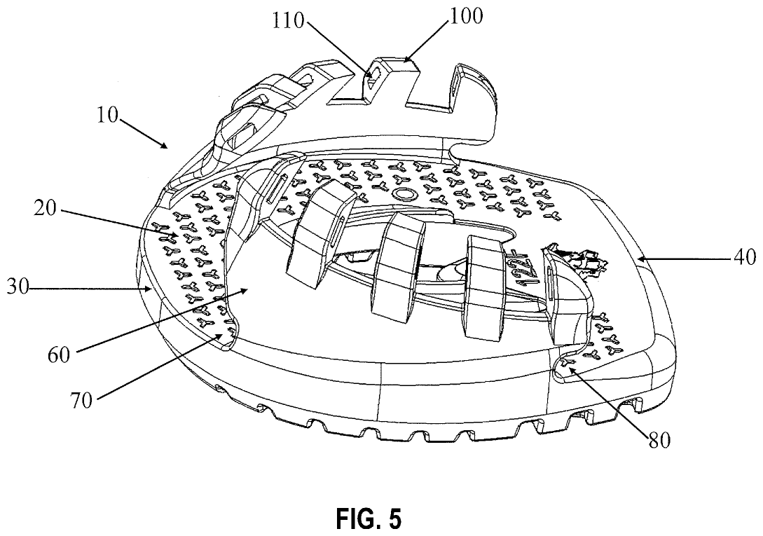

Lateral walls 60 are provided with distal cutouts 70 (for example, in FIGS. 4, 6, 9, and 13) and a proximal cutout 80 (for example, in FIGS. 2, 4, 5, 15 and 17). Such cutouts dramatically improves the fit and adherence of shoe 10 to the horse hoof. In particular, proximal cutout 80 improves fit on horse hooves and adherence to horse hooves by increasing the surface area adhered to the hoof, while permitting additional hoof and shoe flexion without breaking the adhesive bond. Thus, when in use, distal cutout 70 and a proximal cutout 80 allow for expansion and contraction, as well as growth of the horse hoof. In another embodiment (FIGS. 5-18), shoe 10 and cuff 120 can be interlocked and pinned to the horse hoof with a flat, curved pin 150 or a tie.

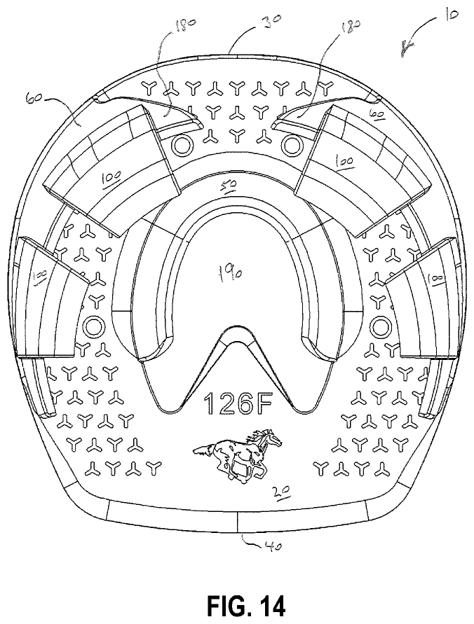

As shown in FIG. 1, platform 20 has a distal end 30 and a proximal end 40, as well as an upper surface and a sole with treads 160. The upper surface is shaped to receive a horse hoof. Moreover, to improve hoof traction on platform 20, the upper surface of the platform is provided with a textured surface. The sole is provided with treads 160 to improve traction in use. Distal end 30 is shaped to receive the toe of a horse hoof. Proximal end 40 is sized to receive the heel of a horse hoof. As shown in FIGS. 14 and 16-18, the interior of the platform 20 is generally formed in the shape of a segmented arc with a central void 190, which is configured to comfortably accommodate and support the frog of the horse hoof. Raised interior skirt 50 is provided along the periphery of the segmented arc to provide improved support and fit. The quarters of the horse hoof is sized to fit between the proximal cutouts 80 and adjacent to the lateral walls 50.

In one embodiment the lateral raised lateral wall 60 and the platform 20 are provided as an integral shoe. However, lateral walls 60 can also be provided as separate parts, thus permitting welding of the lateral walls to prior art urethane shoes. Lateral walls 60, as shown in FIGS. 1-4, can be provided as a cambered urethane sheet, which can be readily welded to platform 20, as well as other urethane shoes. In general, the lateral walls include proximal and distal curvilinear recesses, which are depicted as cutouts 70 and 80 in FIGS. 1 and 8.

In one embodiment describing FIG. 4, the lateral wall includes several circular holes 90. The circular holes 90 can be utilized as holes for nails. The nails can be used to secure the lateral raised lateral wall 60 to the horse hoof. In one embodiment a glue is used to secure lateral walls 60 to the horse hoof.

In one embodiment the proximal end 40 of the shoe 10 is a material that can be readily shaved, such as urethane. This permits a user to precisely shave platform 20 to conform to the size and shape of the horse heel. The more precise proximal fit reduces the likelihood of the shoes interfering with a horse's gallop or other movement.

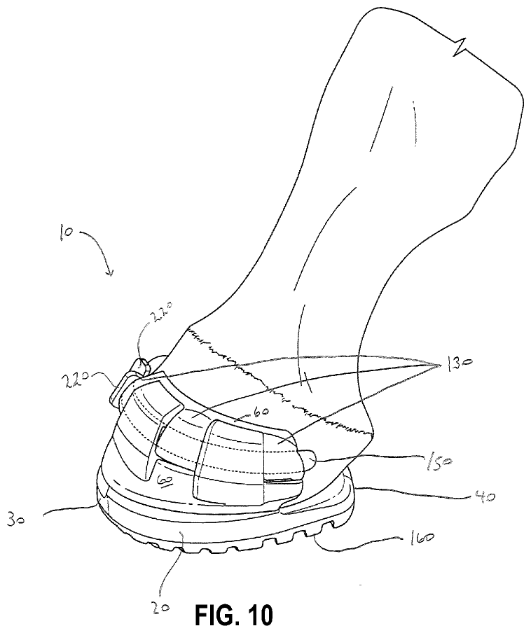

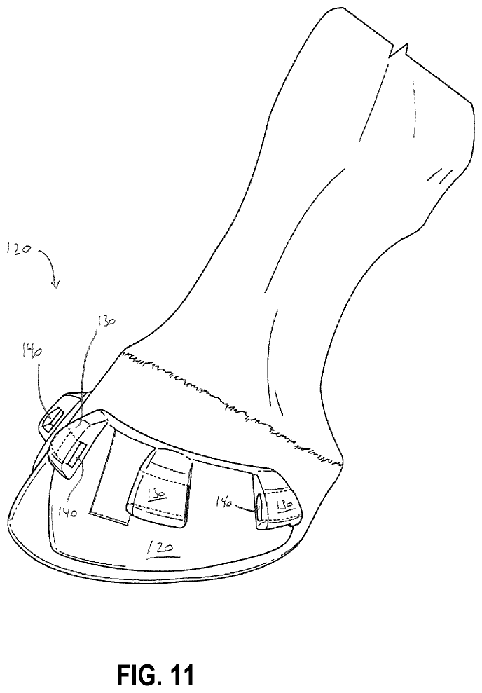

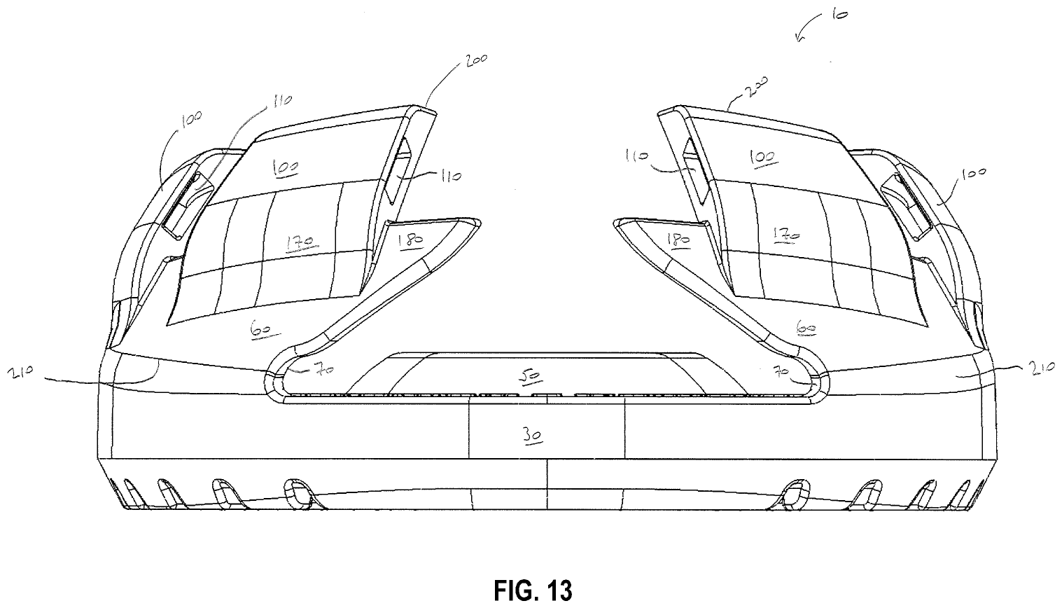

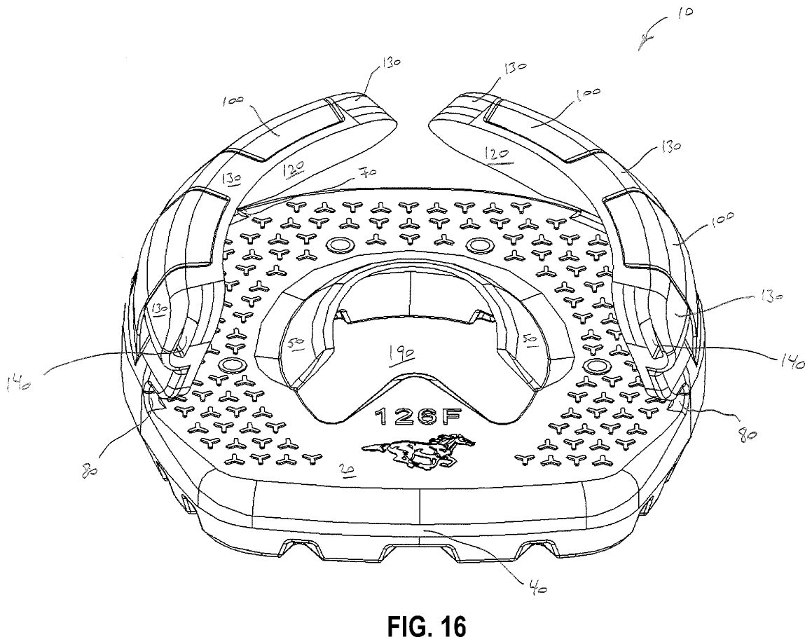

FIGS. 5-8 and 9-18 depict alternative embodiments of shoe 10 in which a cuff with projections is interlocked to lateral wall 60 using a pin 150. In particular, pin 150 is slidable laterally along passageways 110 and 140. The pin 150 is configured as a curved, flat pin with end with stops 220 (FIG. 10), although a number of alternative variants are contemplated by the present disclosure. For example, standard zip ties, elastic ties, or pins having cotter pins can be used. Moreover, multiple pins 150 can be interconnected with a central strap, thus keeping both pins together and preventing pins from inadvertently falling out when in use. As depicted in FIGS. 5-18, the shoe 10 has a platform 20. The platform 20 has a distal end 30 and a proximal end 40. Shoe 10 is sized and shaped to receive a horse hoof, as shown in FIGS. 10-11. The distal end 30 is sized to receive the toe of a horse hoof. The proximal end 40 is sixed to receive the heel of a horse hoof. The interior of the platform 20 defines a void 190, as depicted in FIGS. 14 and 16, for example. The interior of platform 20 and void 190 defines an raised interior skirt 50, as best shown in FIG. 13.

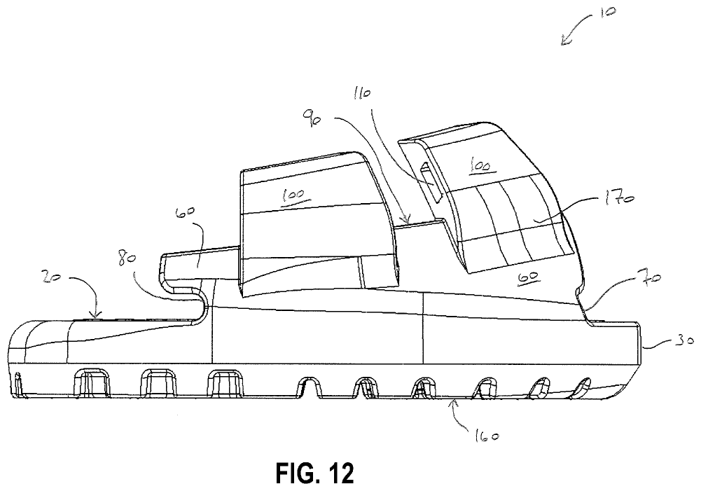

Referring to FIGS. 12-15, raised lateral walls 60 form an outer shell of the shoe 10. Lateral walls 60 are optionally provided with distal cutouts 70 and proximal cutouts 80. The distal cutout 70 and a proximal cutout 80 allow for unencumbered expansion and contraction of a house hoof. The toe of a horse hoof can be accommodated by a generally triangular gap formed wings 180, distal cutouts 70 and platform 20.

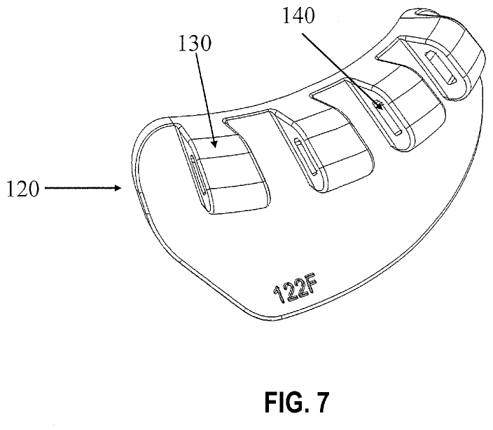

Raised lateral walls 60 have superior end 200 and inferior end 210, as shown in FIG. 13. The superior end has a first set of projections 100 extending from the lateral raised lateral wall 60. The first set of projections 100 have generally central passageways 110 with slopes 170. As shown in FIG. 7, each cuff 120 has a superior end 200 and an inferior end 210. Cuffs 120 have a second set projections 130, which extend from the superior end towards the inferior end of the cuff 120. The second set of projections 130 have a truncated ramp or sloped shape with a central cuff passageway 140. In use, cuffs 120 are glued to the horse hoof, as shown in FIG. 11. Once the glue is cured, shoe 10 can be pivoted onto cuffs 120 and pinned by inserting pins 150 through passageways 140. In the event passageways 140 are clogged with dirt, pin 150 can be pushed through the passageways to clear out such dirt.

Raised lateral walls 60 can be made of a flexible material such as urethane. In another embodiment the platform 20 and the lateral wall 90 are formed as a uniform structure.

To fit the shoes of FIGS. 1-9, a user must first size each hoof. This can be accomplished by measuring the width and length of each hoof with a fit-kit, such as supplied by Easycare, Inc. Based on the width and length of each hoof, a shoe of a proper size is selected. Upon selection, the horse hoof is first prepared using traditional hoof care methods. For example, to ensure proper adhesion, the hoof can be roughed using a rasp or other appropriate tool and cleaned of dust, preferably three times.

For the embodiment of FIGS. 1-4, an adhesive is then applied to the interior of lateral walls 60, as well as the horse hoof. The shoe is then pressed onto the hoof and wrapped with plastic wrap until an adhesive bond is formed, at which time the plastic wrap can be removed. Once adhered to the hoof, the proximal end of the platform can be shaved into a shape that corresponds with the horse hoof. The process is repeated for each hoof.

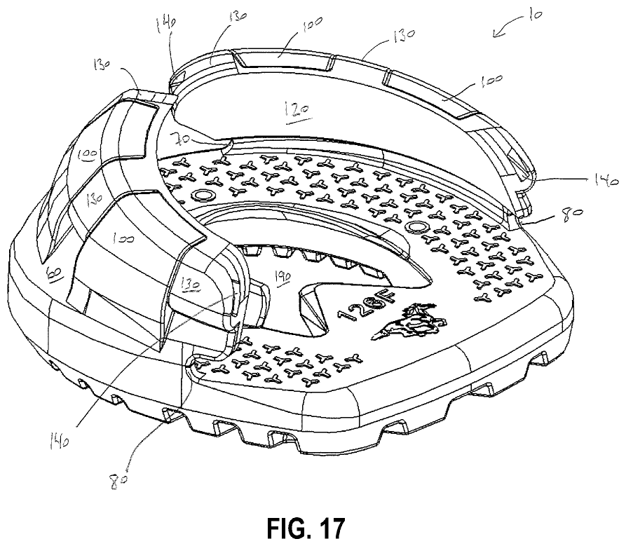

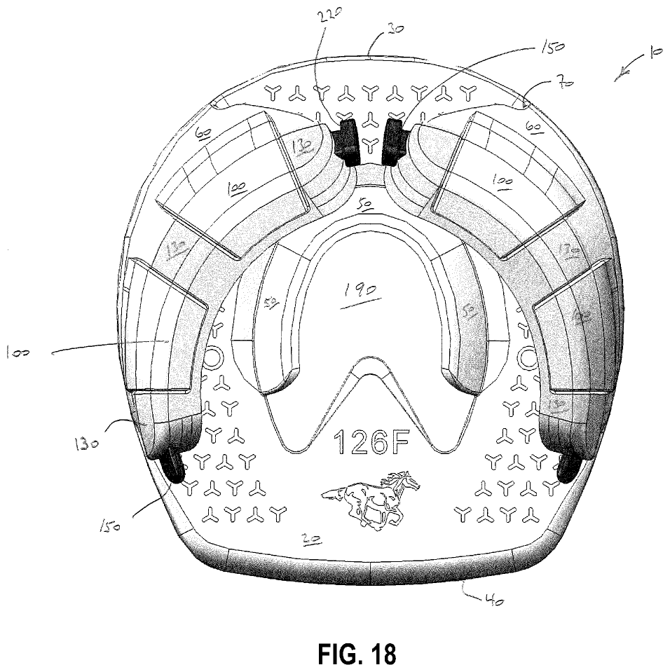

For the embodiment of FIGS. 5-18, an adhesive is applied to the entire interior surface of cuff 120, which is then pressed onto the horse hoof until cured (FIG. 11). Once adhered to the horse hoof, shoe 10 can be pivoted onto the horse hoof such that projections 130 interconnect with projections 100, as depicted in FIG. 17. Pin 150 is then inserted through passageways 140 and 110, thus interlocking the shoe and the cuff, as shown in FIG. 18. The process is repeated for each hoof. When a horse has cuffs 120, any number of different shoes 10—for example, with different treads and tractions—can be quickly exchanged based on the anticipated riding conditions.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

1. A shoe comprising:
a platform having a proximal end, a distal end, an interior opening therebetween, and an outer circumference, wherein the platform is shaped to receive the sole of a horse hoof;
the platform having a first lateral wall extending from the outer circumference, the first lateral wall having a distal cutout and a proximal cutout, and a second lateral wall extending from the outer circumference, the second lateral wall having a distal cutout and a proximal cutout, wherein the first and second lateral walls are configured for adhesion to a horse hoof wall, and the cutouts permit growth and flexibility of a horse hoof.

2. The shoe of claim 1, wherein the platform and lateral walls are formed from urethane.

3. The shoe of claim 2, wherein the platform and the lateral walls are integrally molded.

4. The shoe of claim 2, wherein the platform and lateral walls are joined with a heat-welded union.

5. The shoe of claim 3, wherein the lateral walls includes define a plurality of holes.

6. The shoe of claim 5, wherein the holes are used to nail lateral walls to the horse hoof.

7. The shoe of claim 1, further comprising an adhesive on a portion of the lateral walls.

8. The shoe of claim 7, wherein the adhesive is a cyanoacrylate glue.

9. The shoe of claim 1, wherein the proximal end of the shoe is formed from a shaveable material.

10. A shoe comprising:
a platform having a collar-shaped periphery, a proximal end, and a distal end, wherein the platform is shaped to receive the sole and heel of a horse hoof;
a lateral wall connected to a peripheral portion of the platform, the lateral wall comprising a superior end and an inferior end opposite of the superior end, the inferior end being connected to the platform, the superior end having a plurality of projections defining a first passageway;
a cuff having a plurality of sloped projections defining a second passageway, the cuff projections being interconnected with the lateral wall projections; and
a pin inserted through the first and second passageways, thereby laterally interlocking the cuff and the lateral wall.

11. A shoe comprising:
a platform having a proximal end, a distal end and a skirt therebetween, the skirt forming a segmented arch and defining a void, wherein the platform is shaped to receive the sole and heel of a horse hoof;
a first lateral wall having a proximal portion and a distal portion, the first lateral wall being connected to a peripheral portion of the platform, the first lateral wall comprising
an elongate proximal cutout in the proximal portion and an elongate distal cutout in the distal portion, wherein the cutouts are configured to receive portions of a horse hoof and permit expansion and contraction of such a horse hoof;
a superior end and an inferior end opposite of the superior end, the inferior end being connected to the platform,
the superior end having a plurality of projections defining a first passageway
a second lateral wall having a proximal portion and a distal portion, the second lateral wall being connected to a peripheral portion of the platform, the second lateral wall comprising
an elongate proximal cutout in the proximal portion and an elongate proximal cutout in the distal portion, wherein the cutouts are configured to receive portions of a horse hoof and permit expansion and contraction of such a horse hoof;
a superior end and an inferior end opposite of the superior end, the inferior end being connected to the platform,
the superior end having a plurality of projections defining a second passageway.

12. The shoe of claim 11, further comprising:
a first cuff having a plurality of projections defining a third passageway, the cuff projections interconnecting with the first lateral wall projections;
a second cuff having a plurality of projections defining a fourth passageway, the second cuff projections interconnecting with the second lateral wall projections; and
a first pin removably inserted through the first and third passageways, thereby interlocking the first cuff and the first lateral wall; and
a second pin removably inserted through the second and fourth passageways, thereby interlocking the second cuff and the second lateral wall.

13. A cuff comprising:
a cambered urethane sheet, the sheet comprising a proximal portion, a distal portion, and a portion therebetween, the proximal portion defining a proximal curvilinear recess and the distal portion defining a distal curvilinear recess, wherein the cutouts are configured to receive portions of a horse hoof and permit expansion and contraction of such a horse hoof.

14. A method of shoeing a horse, comprising:
rasping the hoof of a horse to create a rough portion on the hoof;
providing a shoe comprising:
a platform having a collar-shaped periphery, a proximal end, and a distal end, wherein the platform is shaped to receive the sole and heel of a horse hoof;
a lateral wall connected to a peripheral portion of the platform, the lateral wall comprising a superior end and an inferior end opposite of the superior end, the inferior end being connected to the platform, the superior end having a plurality of projections defining a first passageway;
a cuff having a plurality of sloped projections defining a second passageway, the cuff projections being interconnected with the lateral wall projections; and
a pin;
applying an adhesive to the cuff;
adhering the cuff to the horse hoof;
pivotally connecting the lateral wall to the cuff; and
inserting the pin through the first and second passageway, thereby interlocking the lateral wall and the cuff.
